(19) United States
(12) Patent Application Publication
(10) Pub. No.: US 2009/0255166 A1
(43) Pub. Date: Oct. 15, 2009

(54) Hand net

(75) Inventor: Ting An Lu, Tung Shan Hsiang (TW)

Correspondence Address: BACON & THOMAS, PLLC, 625 SLATERS LANE, FOURTH FLOOR, ALEXANDRIA, VA, 22314-1176, US

(73) Assignee: Li To ENTERPRISE, Tung Shan Hsiang (TW)

(21) Appl. No.: 12/382,954

(22) Filed: Mar. 27, 2009

(30) Foreign Application Priority Data
Mar. 28, 2008 (TW) 097111258

(51) Int. Cl. A01K 77/00

(52) U.S. Cl. 43/12

(57) ABSTRACT

A hand net comprises a rod body, of which one end has a handle portion and the other end supports a net portion through a hoop, in which the hoop includes: a T-shaped member of which one end is connected to the rod body and the other two ends form a pair of opposite support ends, each support end being provided with a pivot bearing portion; a pair of flexible rods passing through a roll-rim channel of the net portion respectively. One end of each flexible rod has a ball stud pivotally mounted in the pivot bearing portion. The other ends of the flexible rods can be detachably connected with each other through a pair of connection bars.

### BACKGROUND OF THE INVENTION

1. Field of the Invention

This invention relates to a hand net, especially to a hand net in which the net portion can be unfolded rapidly when in use and can be folded for convenient storage and transportation.

2. Brief Description of the Prior Art

Generally, a hand net has a huge volume and is not convenient to be carried for the people for excursion purpose such as fishing or collecting specimen. In order to improve the defects of conventional hand net, several relevant documents have been proposed. For example, a Taiwanese Utility Patent No. 281000 entitled “Improvement on Hoop Frame of Hand Net”, as shown in FIGS. 11 and 11a, discloses a frame body (30′) having square cross section which has ribs formed respectively on top portion and bottom portion in order to reinforce the frame body (30′). The frame body (30′) is formed by three arc segments (33′, 34′, 35′). Connecting portions (36′) each provided with a mating surface (37′) are provided for connecting any adjacent two of the first arc segments (33′), the second arc segments (34′) and the third arc segments (35′) to each other in such a manner that one mating surface (37′) is lapped on anther mating surface (37′) while the mating surfaces (37′) lapped on each other are riveted together by a rivet (C′). A connecting portion (38′) from which a bolt (39′) is radially and outwardly extended is provided at the other end of the first arc segments (33′). Correspondingly, a connecting portion (41′) is provided at the other end of the third arc segments (35′), and an receiving portion (42′) with a through hole is formed at the outside of the connecting portion (41′) for fitting with the connecting portion (38′). The bolt (39′) is inserted through the through hole and screwed into a rod body (45′). In this manner, a foldable hoop frame (30′) of the hand net for supporting the net portion (44′) is formed.

The above disclosure can reach the goal of reducing the volume of the hand net. However the person skilled in the art can understand that the three arc segments (33′, 34′, 35′) can be reconfigured from a circular shape to an elliptical shape which still occupies an undesirable volume. Further, when folding the hoop, the hoop has to be separated from the net portion (44′) such that the assembling the hand net will become very complicated. Hence, this will result in inconvenience in use.

### SUMMARY OF THE INVENTION

The main object of the present invention is to provide a hand net device which is capable of reduction of volume so as to be carried conveniently.

In order to achieve above and other objects, the hand net of the present invention comprises a rod body, one end of which has a handle portion and the other end supports a net portion through an hoop, in which the hoop includes: a three-way connection member one end of which is connected to the rod body and the other two ends of which form a pair of opposite support ends each provided with a pivot bearing portion; a pair of flexible rods passing through a roll-rim channel of the net portion, one end of each flexible rod having a ball joint pivotally mounted in the pivot bearing portion so as to be folded with respect to the rod body, the other end of each flexible rod being detachably connected at the other end with one another through a pair of connecting bars so as to form a hoop.

According to the hand net of the present invention, in a folded state, the pair of flexible rods are parallel with the rod body and shrunk into a small bundle with the net portion for easy storage and transportation. When in use, the pair of flexible rods is flexibly bent so that the flexible rods are connected with each other rapidly so as to form a hoop supporting the net portion.

According to the present invention, the hoop is formed of carbon fiber which is low-weight and tough. The cross section of the pair of flexible rods is in elliptical shape, the direction of its major axis is in coincidence with the weight-loading direction of the net portion, and the direction of its minor axis is in coincidence with the bending direction of the hoop. Therefore, the flexible rods can be bent easily in the direction of the minor axis and have a good bending strength against a load in the direction of the major axis, the load being caused by weight of an object captured in the net portion.

### BRIEF DESCRIPTION OF THE DRAWINGS

FIG. 1 is a perspective view showing the embodiment of the hand net according to the present invention, in which the net portion is in a folded state;

FIG. 2 is a perspective view showing the embodiment of the hand net according to the present invention, in which the net portion is in an unfolded state;

FIG. 2a is partial enlarged sectional view taken along the 2a-2a direction in FIG. 2;

FIG. 2b is a partial enlarged view showing the encircled portion in FIG. 2;

FIG. 3 is a perspective view showing the three-way connection member to which two swinging arms are to be attached;

FIG. 4 is a sectional view of the three-way connection member;

FIG. 4a is a side view of the three-way connection member;

FIG. 4b is a bottom view of the three-way connection member;

FIG. 4c is a top view of the three-way connection member;

FIG. 5 is a top view of the swinging arm;

FIG. 5a is a partial enlarged sectional view taken along the 5a-5a direction in FIG. 5;

FIG. 6 is a top view the first connection bar and the second connection bar;

FIG. 6a is a side view seen from the direction 6a-6a in FIG. 6;

FIG. 7 shows the process that the flexible rods form the hoop, in which the net portion is omitted for clarity

FIG. 8 is a partial enlarged sectional view showing the hand net in the unfolded state;

FIG. 9 is a side view showing the hand net in the unfolded state;

FIG. 10 show a configuration for connecting the three-way connection member and the rod body;

FIG. 11 shows the foldable hoop of the conventional hand net; and

FIG. 11a shows the convention hand net as disclosed in the Taiwanese Utility Patent No. 2841000.

### DETAILED DESCRIPTION OF THE PREFERRED EMBODIMENTS

The technical contents of the present invention will become more apparent from the detailed description of the preferred embodiments in conjunction with the accompanying drawings. It is noted that the preferred embodiments are purely for illustrative, not for restrictive purpose.

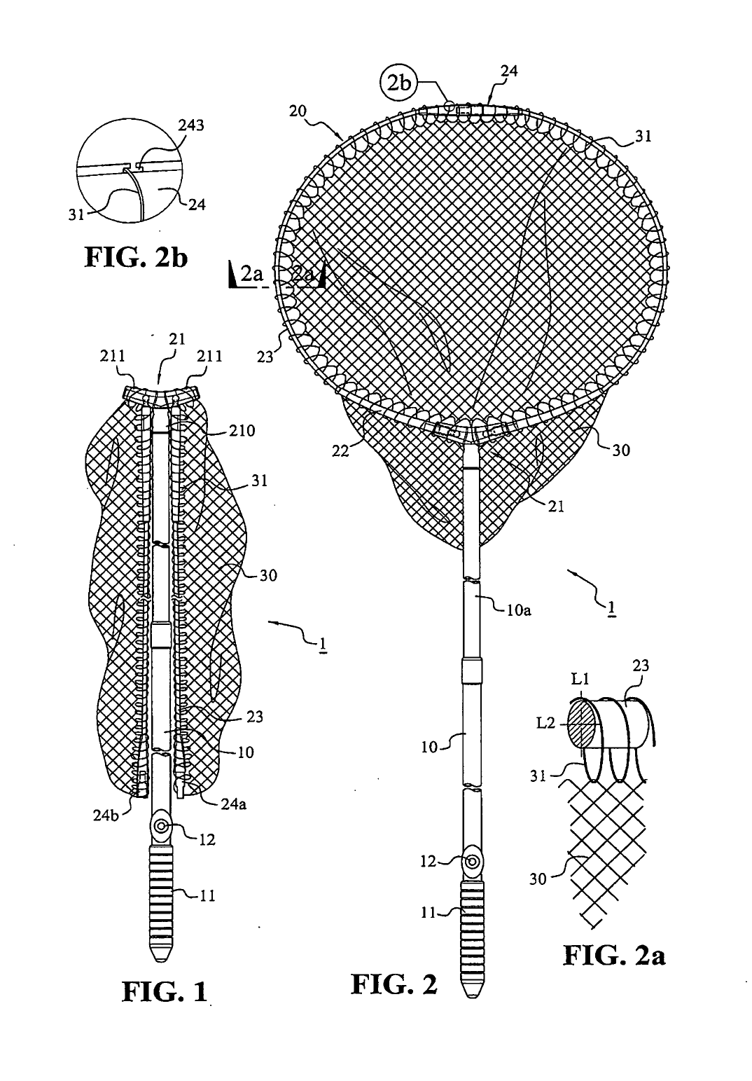

Firstly referring to FIGS. 1 and 2, the hand net 1 according to the present invention comprises a rod body 10. For example, the rod body 10 may include at least one extendable rod 10a. One end of the rod body 10 has a handle portion 11, and the other end of the rod body 10 supports a net portion (mesh basket) 30 through a hoop 20.

The hand net 1 further comprises: a three-way connection member 21 one end 210 of which is connected to the rod body 10 and the other two ends of which form a pair of opposite support ends 211 each provided with a pivot bearing portion 212; a pair of flexible rods 23 passing through a roll-rim channel 31 of the net portion 30. One end of each flexible rod 23 has a ball joint 221 pivotally mounted in the pivot bearing portion 211 so as to be folded with respect to the rod body 10. The flexible rods 23 can be bent and detachably connected with each other at the other end through a pair of connecting bars 24 such that the pair of flexible rods 23 can be reconfigured as the hoop 20.

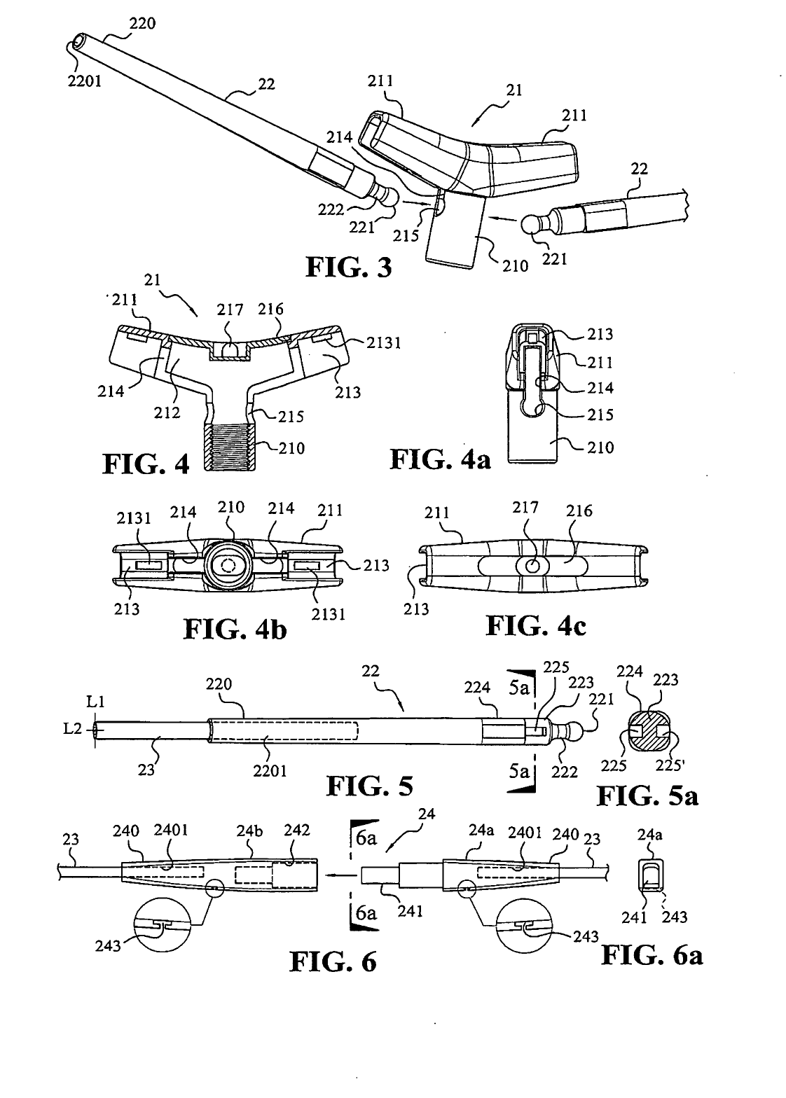

As shown in FIGS. 3 and 4c, the three-way connection member 21 is a hollow T-shaped member which is, for example, made of carbon fiber. The three-way connection member 21 has a connection end 210 connected to the rod body 10 and the other two ends forming a pair of opposite support ends 211. Receiving portions 213 opened in the lateral direction and toward the connection end 210 are respectively formed at the outer sides of the support ends 211, and pivot bearing portions 212 are formed respectively at the inner sides of the support ends 211.

The hand net of the present invention further includes a pair of swinging arms 22 interposed respectively between the support ends 211 of the three-way connection member 21 and the flexible rods 23. The swinging arms are, for example, made of carbon fiber. One end of each swinging arm 22 is a connection end 220 having one hole 2201 for receiving one end of each flexible rods 23, and the other end of each swinging arm 22 forms a ball joint 221 pivotally mounted in the pivot bearing portion 212 of the three-way connection member 21. Each flexible rod 23 is, for example, made of carbon fiber, the cross sections of which is an ellipse having a major axis L1 and a minor axis L2, as shown in FIG. 2a. The direction of the major axis L1 is in coincidence with the weight-loading direction of the net portion 30, and the direction of the minor axis L2 is in coincidence with the bending direction of the flexible rod 23 such that each flexible rod 23 is easily bent in the L2 direction and can sustain more weight in the L1 direction. The cross section of the other shapes such as rectangular shape, I shape, polygonal, irregular shape and the like can be applied to the flexible rod.

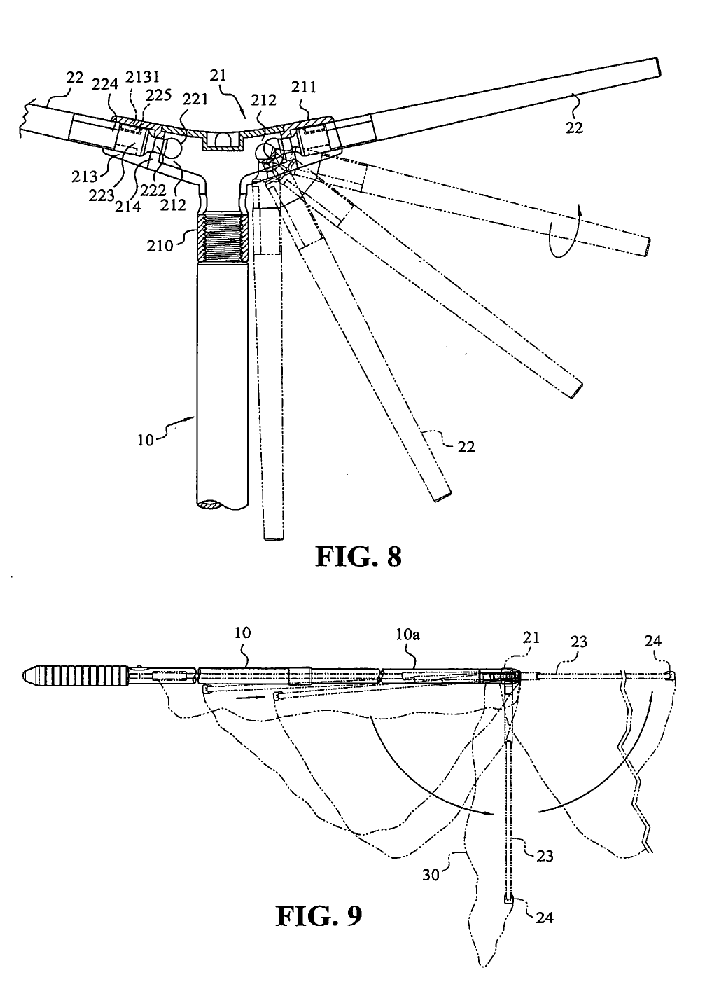

Referring to FIGS. 4 and 5, each receiving portion 213 of the three-way connection member 21 of the present invention has a U-shaped cross section, the width of which is larger than the cross sectional width of the pivot bearing portion 212, and a slot 214 extends over the pivot bearing portion 212 and the receiving portion 213 and extends to the connection end 210, as shown in FIG. 4a. A neck portion 222 corresponding to the receiving portion 213 and having a diameter slightly smaller than the width of the slot 214 is formed each swinging arm 22 at a location near the ball joints 221 such that the swinging arm 22 can pivot and pass through the slot 214, as shown in FIG. 8. Each slot 214 extends to the side wall of the connection end 210 of the three-way connection member 21, and a circular hole 215 having a diameter slightly greater than that of the ball joint 221 is formed at the end of the slot 214 on the side wall of the connection end 210 such that the ball joint 221 can access to the pivot bearing portion 212 via the circular hole 215.

Further, a segment 223 with a circular cross section having a diameter slightly smaller than the cross sectional width of the receiving portion 213 is formed next to the neck portion 222 of the swinging arm 22. Corresponding to the U-shape cross section of each receiving portion 213, a rectangular cross sectional segment 224 is formed next to the segment 223 with the circular cross section as shown in FIG. 5a. The cross section of each swinging arm 22 is gradually formed into an elliptic shape in correspondence with that of the flexible rod 23 and tapers gradually from the rectangular cross sectional segment 224 toward the connection end 220. Each flexible rod 23 is inserted into the connection end 220 by a depth at least larger than ⅓ of the length of the swinging arm 22 so that the connection end 220 can be bended accompanying with the bending of the flexible rod 23. Furthermore, a positioning key 2131 is formed at the top inner wall of each receiving portion 213 of the three-way connection member 21, and positioning key slots 225 and 255′ are formed on the segment 223 having circular section of each swinging arm 22 in such a manner that the opening direction of the positioning key slots 225 and 255′ is in coincidence with the direction of the minor axis L2 of the cross section of the flexible rod 23. The positioning key 2131 can be inserted into one of the positioning key slots 225 and 255′ when the flexible rods are reconfigured as the hoop 20.

Referring to FIGS. 6 and 6a, a pair of connection bars 24 including a first connection bar 24a and a second connection bar 24b, for example, made of carbon fiber are provided on the flexible rods (23) at ends opposite to the swinging arms for connection with each other. One end of the first connection bar 24a and one end of the second connection bar 24b are connection ends 240 each having a hole 2401 for receiving one end of the flexible rod 23. The other end of the first connection bar 24a has a projecting pin 241, and the second connection bar 24b has a hole 242. The projecting pin 241 is detachably fitted into the hole 242. The projecting pin 241 and the hole 242 are stepped in order to avoid any unexpected disconnection between the first and second connection bars 24a and 24b. A T-shaped groove 243 is provided on an outer surface of each of the first connection bar 24a and the second connection bar 24b for holding the net portion 30, as shown in FIG. 2b, and for keeping the net portion 30 in place in a folded state of the net portion 30 as shown in FIG. 1.

As shown in FIG. 4c, an opening 216 facing the hoop 20 in unfolded state is formed between the two support ends 211 of the three-way connection member 21. A LED lamp 217 is provided in the opening 216. A battery device and a switch 12 for turning the LED lamp 217 on and off by a conventional wire or wireless manner are provided in the interior of the handle portion 11 of the rod body 10 such that light can be emitted toward the hoop 20 (i.e., the opening of the net portion 30) at night.

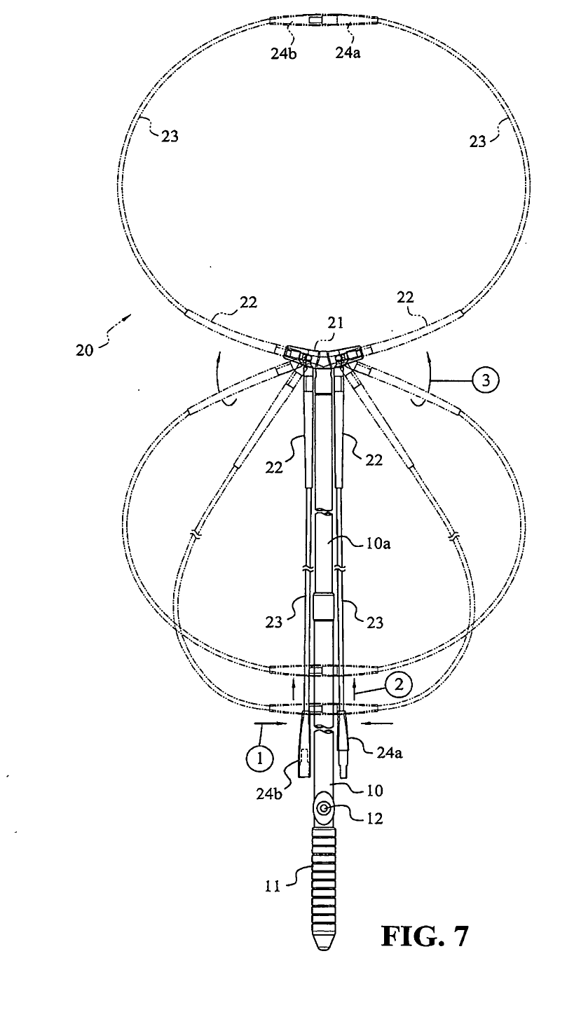

The process for unfolding the net portion 30 will be described with reference to FIGS. 7 to 9. In a folded state, the pair of flexible rods 23 are inserted into the roll-rim channel 31 of the net portion 30, and a part of the net portion 30 is held by the T-shaped groove 243. In order to unfold the hand net, the pair of flexible rods 23 are bended oppositely so that the first connection bar 24a and the second connection bar 24b are connected to each other as shown in the encircled portion 1 in FIG. 7. Then, the pair of connection bars 24 which are connected with each other are pushed toward the three-way connection member 21 so that the pair of flexible rods 23 are reconfigured as the hoop as shown in the encircled portion 2 in FIG. 7. Finally, the hoop 20 is turned over by 180 degrees with respect to the rod body 10 such that the positioning keys 2131 on the top inner wall of the receiving portion 213 of the three-way connection member 21 are inserted into the positioning key slots 225 on the segments 223 having circular cross section of the swinging arms 22 (as shown in the encircled portion 3 in FIG. 7). In this manner, the net portion 30 can be unfolded rapidly, as shown in FIG. 2. The net portion 30 can be extended further by the extendable rod 10a. When the hand net is out of use, the net portion 30 can be folded into the folded state as shown in Figure according to the reverse order of the above steps.

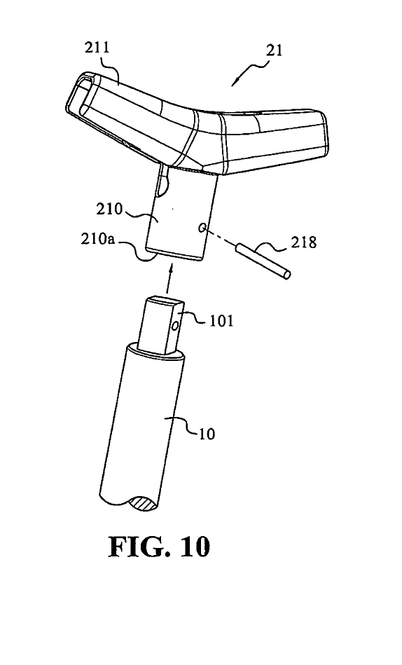

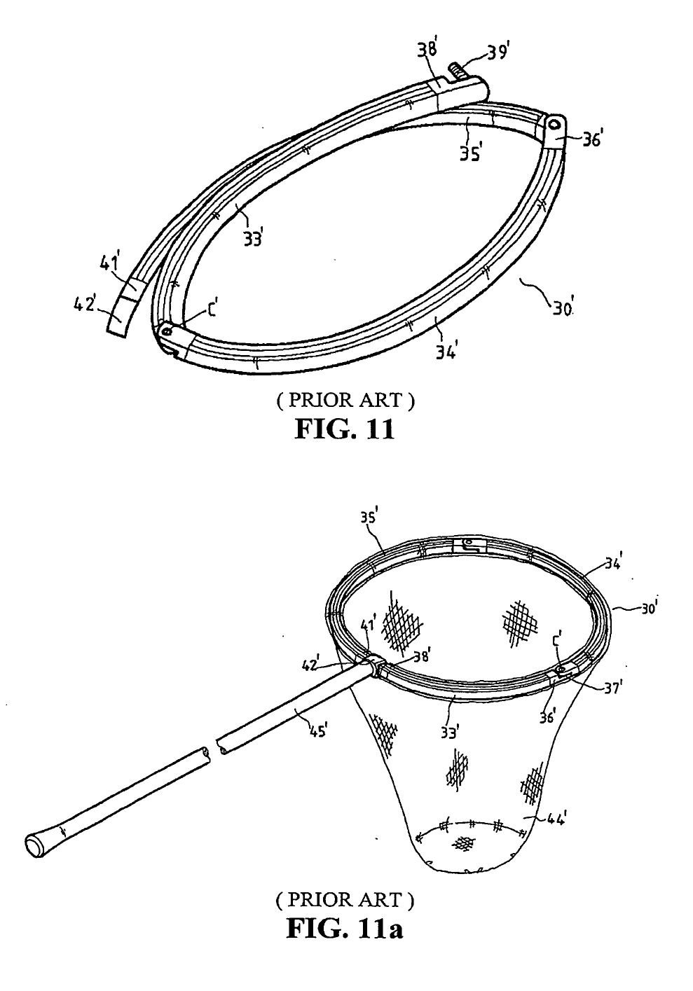

According to the present invention, the three-way connection member 21 may be connected with the rod boy 10 by means of threads. A connection configuration for connecting the three-way connection member 21 with the rod boy 10 is shown in FIG. 10. One end of the rod body 10 is formed with a tenon 101 while the connection end 210 of the three-way connection member 21 is correspondingly formed with a mortise 210a. An insertion pin is inserted through the tenon 101 and the mortise 210a for presenting the tenon 101 from disconnecting from the mortise 210a.

Summing up above, the net portion of the hand net of the present invention can be unfolded quickly when in use and can be folded for easy storage and transportation when out of use. Thus, the hand net surely is an invention having creativity, inventive step and industrial availability.

While the preferred embodiment has been shown and described in detail as above, it is noted that the preferred embodiment is not restrictive to the scope of implementation of the present invention. Modifications and variations may be made without departing from the spirit or scope of the appended claims.

What is claimed is:

1. A hand net (1), comprising a rod body (1), one end of which has a handle portion (11) and the other end of which is provided with a hoop (20) for supporting a net portion (30), wherein said hoop (20) includes:
a three-way connection member (21) having a connection end (210) connected to said rod body (10) and a pair of opposite support ends (211), each support end being provided with a pivot bearing portion (212);
a pair of flexible rods (23) passing through a roll-rim channel (31) of the net portion (30), one end of each flexible rod (23) having a ball joint (221) pivotally mounted in said pivot bearing portion (211) so that each flexible rod (23) is capable of being rotated with respect to said three-way connection member (21) so as to be folded on said rod body (10), each flexible rod (23) being bended and connected with one another so as to form the hoop (20).

2. A hand net (1) according to claim 1, wherein said three-way connection member 21 is formed as a hollow T-shaped member which forms receiving portions (213) opened in a lateral direction and toward the connection end (210) respectively at outer sides of said support ends (211), and the pivot bearing portions (212) respectively at inner sides of said support ends (211).

3. A hand net (1) according to claim 2, wherein each said receiving portion (213) has a U-shaped cross section with a width larger than a cross sectional width of said pivot bearing portion (212), and a slot (214) extending over said pivot bearing portion (212) and said receiving portion (213) and extending to a side wall of said connection end (210).

4. A hand net (1) according to claim 2, wherein the cross section of each flexible rod (23) is an ellipse having a major axis (L1) and a minor axis (L2), a direction of said major axis (L1) is in coincidence with a weight-loading direction of said net portion (30), and a direction of said minor axis (L2) is in coincidence with a bending direction of said hoop (20).

5. A hand net (1) according to claim 4, wherein a pair of swinging arms (22) are interposed respectively between said support ends (211) of said three-way connection member (21) and said flexible rods (23).

6. A hand net (1) according to claim 5, wherein one end of each swinging arm (22) is a connection end (220) having one hole (2201) for receiving one end of each flexible rod (23) and the other end of each swinging arm (22) forms the ball joint (221) pivotally mounted in said pivot bearing portion (212) of said three-way connection member (21).

7. A hand net (1) according to claim 4, wherein each said flexible rod (23) is inserted into the connection end (220) by a depth at least larger than ⅓ of a length of said swinging arm (22).

8. A hand net (1) according to claim 6, wherein a neck portion (222) corresponding to said receiving portion (213) and having a diameter slightly smaller than the width of the slot (214) is formed at a location near said ball joints (221) of each said swinging arm (22).

9. A hand net (1) according to claim 8, wherein each slot (214) extends toward the side wall of said connection end (210) of said three-way connection member (21), and two circular holes (215) each having a diameter slightly greater than that of the ball joint (221) are formed on the side wall.

10. A hand net (1) according to claim 8, wherein a segment (223) having a circular cross section having a diameter slightly smaller than the cross sectional width of said receiving portion (213) is formed inside next to said neck portion (222) of said swinging arm (22); and corresponding to the U-shape cross section of each receiving portion (213), a square cross sectional segment (224) is formed inside next to said segment (223) having the circular cross section.

11. A hand net (1) according to claim 10, wherein a positioning key (2131) is formed at a top inner wall of each receiving portion (213) of the three-way connection member (21), a positioning key slot (225) is correspondingly formed on said segment (223) of each swinging arm (22) having the circular section, and said positioning groove (225) opened in the direction of said minor axis (L2) of said flexible rod (23).

12. A hand net (1) according to claim 1, further comprising a pair of connection bars (24) which are composed of a first connection bar (24a) and a second connection bar (24b) provided on the flexible rods (23) at ends opposite to the swinging arms for connection with each other.

13. A hand net (1) according to claim 12, wherein one end of said first connection bar (24a) and one end of the second connection bar (24b) are connection ends (240) having holes (2401) for receiving ends of the flexible rods (23) respectively, while the other ends of said first connection bar (24a) and said second connection bar (24b) are respectively provided with a projecting pin (241) and a hole (242), said projecting pin (241) being detachably fitted into said hole (242).

14. A hand net (1) according to claim 13, wherein a T-shaped groove (243) is provided on an outer surface of each of said first connection bar (24a) and said second connection bar (24b).

15. A hand net (1) according to claim 2, wherein an opening (216) facing said hoop (20) in an unfolding state is formed between the two support ends (211) of said three-way connection member (21), a LED lamp (217) being provided in said opening (216), and a switch (12) for turning the LED 217 on and off being provided in the handle portion (11) of said rod body (10).

16. A hand net (1) according to claim 1, wherein one end of said rod body (10) is formed with a tenon (101), said connection end (210) of the three-way connection member (21) is correspondingly formed with a mortise (210a), and a insertion pin is inserted through the tenon (101) and the mortise (210a) for presenting the tenon (101) from disconnecting from the mortise (210a).

17. A hand net (1) according to claim 16, wherein said rod body (10) has at least one extendable segment (10a).
